(19) United States
(12) Patent Application Publication
(10) Pub. No.: US 2006/0217054 A1
(43) Pub. Date: Sep. 28, 2006

(54) Arrangement of a plurality of air nozzles as an air outflow device

(75) Inventors: Wolfgang Hoehn, Russelsheim (DE); Klaus Mayer, Obertshausen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/369,016

(22) Filed: Mar. 7, 2006

(30) Foreign Application Priority Data
Mar. 8, 2005 (DE) 10 2005 010 666.8

(51) Int. Cl. B60S 1/54

(52) U.S. Cl. 454/127

(57) ABSTRACT

The invention relates to an air outflow device in which an air guide element, which is provided with an opening on each of two sides, is rotatably mounted in a bracket which is open on two sides and is matched to the shape of the air guide element, the first of the two openings of the air guide element being connected to an air feed line, and the second of the two openings being directed towards a space which is to be ventilated. According to the invention, the air outflow device is formed by at least two of the air guide elements which are each mounted in a bracket and are arranged next to one another in a faceplate which adjoins the space which is to be ventilated.

### CLAIM FOR PRIORITY

This application claims the benefit of priority to German Application No. 10 2005 010 666.8, filed in the German language on Mar. 8, 2005, the contents of which are incorporated by reference.

### TECHNICAL FIELD OF THE INVENTION

The invention relates to an air outflow device, and in particular, to an air outflow device in which an air guide element is rotatably mounted in a bracket which is open on two sides and is matched to the shape of the air guide element.

### BACKGROUND OF THE INVENTION

DE 197 21 831 A1 discloses an air outflow device in which an air outflow element is connected to an air line of a ventilation device and is mounted so as to be rotatable about an axis. In one particular embodiment, the air outflow element is a so-called ball nozzle which is mounted in a spherical cap. This type of mounting makes it possible to freely set the air outflow direction within wide limits. In DE 197 21 831 A1, the air outflow element is provided with a first region, which is provided with apertures, for a diffuse outflow of air, and a second region, which is provided with apertures, for a free outflow of air over a large area, it being possible to place the desired region in the air flow by rotating the air outflow element. In this way, it is possible to choose between a directed, strong outflow or a diffuse, relatively weak outflow of one individual air flow.

### SUMMARY OF THE INVENTION

The invention relates to an air outflow device in which an air guide element, which is provided with an opening on each of two sides, is rotatably mounted in a bracket which is open on two sides and is matched to the shape of the air guide element, the first of the two openings of the air guide element being connected to an air feed line, and the second of the two openings being directed towards a space which is to be ventilated. Thus, comfort of a person situated in the space which is to be ventilated is improved.

The consideration on which the present invention is based is that, in confined spaces which are to be ventilated, in particular in motor vehicles in which a person is sitting relatively close to an air outflow device, the person is usually exposed to a single, comparatively wide air flow. Though the outflow direction and the intensity of the overall air flow can be varied, the size of the area of impact of the air flow on the person or the surroundings remains constant.

With one embodiment according to the invention, the air outflow device is such that it is formed by at least two of the air guide elements, which are each mounted in a bracket and are arranged next to one another in a faceplate which adjoins the space which is to be ventilated, a considerably greater number of configurations are now made possible. Each of the at least two air outflow devices generates its own air flow which can be individually directed towards the space which is to be ventilated. Sensitive body parts, for example, such as eyes or ears, of the person situated in front of the air outflow device can thus be omitted from the air flow on account of the air flow being divided into at least two parts, and this considerably increases comfort. With the single-part air outflow device, individual body parts can be protected from exposure to flow by deflecting the individual air flow away completely, so that the area surrounding said body parts is also no longer exposed to flow, which may however be desired.

It is preferred that more than two air guide elements are distributed across a certain area of the faceplate, with symmetrical, matrix-like arrangements of equal numbers of air guide elements arranged one above the other and next to one another, that is, for example, of four or nine air guide elements, being particularly suitable for aesthetic reasons. The faceplate can be of any desired shape, that is to say it can be straight or curved. The arrangement of a plurality of preferably relatively small air guide elements across an area offers the advantage that the original individual air flow is divided into a plurality of smaller air flows. The individual distribution of the air flows can be used for a supply of air which feels uniform.

The air guide elements are preferably of equal size, though air guide elements of different sizes are also possible in order, for example, to generate a stronger air flow in the centre of the faceplate and individual, weaker air flows at its periphery. In this way, the distribution of air can be matched to different spatial geometries and comfort requirements.

In one embodiment of the invention, at least two of the air guide elements can be moved independently of one another in their respective brackets, and in another embodiment, at least two of the air guide elements are mechanically connected to one another at their side facing the air feed line, that is to say on the side of their first openings, by means of a connecting rod and can thereby be moved in the same way. Depending on the number of air guide elements, all or else only some of the air guide elements can accordingly be connected to one another, while the rest can be adjusted individually. It is possible as a result to divide the area of the faceplate into individual ventilation zones. One diffuse air flow, which results from the arrangement of a plurality of relatively small air guide elements, is generated per ventilation zone. The connection of the air guide elements associated with the ventilation zone allows them to be adjusted simultaneously and aligned in a targeted manner.

In a further embodiment of the invention, it is possible to set the strength of the air flow respectively supplied by at least two of the air guide elements.

By arbitrarily combining, within a faceplate area, air guide elements which are connected to one another, are individually adjustable, and are of different size and of different flow strength, there are thus no longer any limitations whatsoever on possible configurations of the distribution and direction of air.

In one preferred embodiment, the air guide elements which are associated with the air outflow device and the inner shape of the respectively associated bracket are spherical, that is to say, the air outflow device comprises at least two individual ball nozzles. Ball nozzles have the advantage that they are not only adjustable about one axis, that is to say up and down, but can be adjusted in any desired direction. Accordingly, it is no longer necessary to additionally introduce laterally displaceable air guide plates or flaps within the air guide element.

The ball nozzles described in DE 197 21 831 A1 have a handling recess into which an operator can reach and grip in order to adjust the flow direction of the ball nozzle. Since the ball nozzles used for the air outflow device according to the invention are generally considerably smaller, the installation space for a handling recess of this type is in some cases no longer available, which is why it is proposed in a refinement of the ball nozzle that a handling element projects out from the centre of the spherical air guide element. This interior handling element is preferably a nib which is arranged centrally in the second opening of the air guide element. An operator can grip this handling element with their hand or their fingers and in this way adjust the orientation of the air guide element.

In a further embodiment, to improve the handling of the ball nozzles, a cylindrical air connecting element is integrally formed on the first opening of the air guide elements, that is to say in the direction of the air feed line. This facilitates the production of a mechanical connection between the air supply line and the respective air guide element.

It is also proposed that a cylindrical air outflow element is integrally formed on the second opening of the air guide elements, which air outflow element on the one hand serves to concentrate the air flow so that it flows out of the air outflow element in a directed manner, and said air outflow element can on the other hand serve as a handling element, as long as the air outflow element projects sufficiently far out of the faceplate.

### BRIEF DESCRIPTION OF THE DRAWINGS

The invention is explained in more detail with reference to the exemplary embodiments and the drawings, in which:

FIG. 1 shows an air outflow device in a cockpit of a motor vehicle.

FIG. 2 shows one of the ball nozzles in the air outflow device in FIG. 1.

FIG. 3 shows two individually adjustable ball nozzles.

FIG. 4 shows two connected ball nozzles.

### DETAILED DESCRIPTION OF THE INVETNION

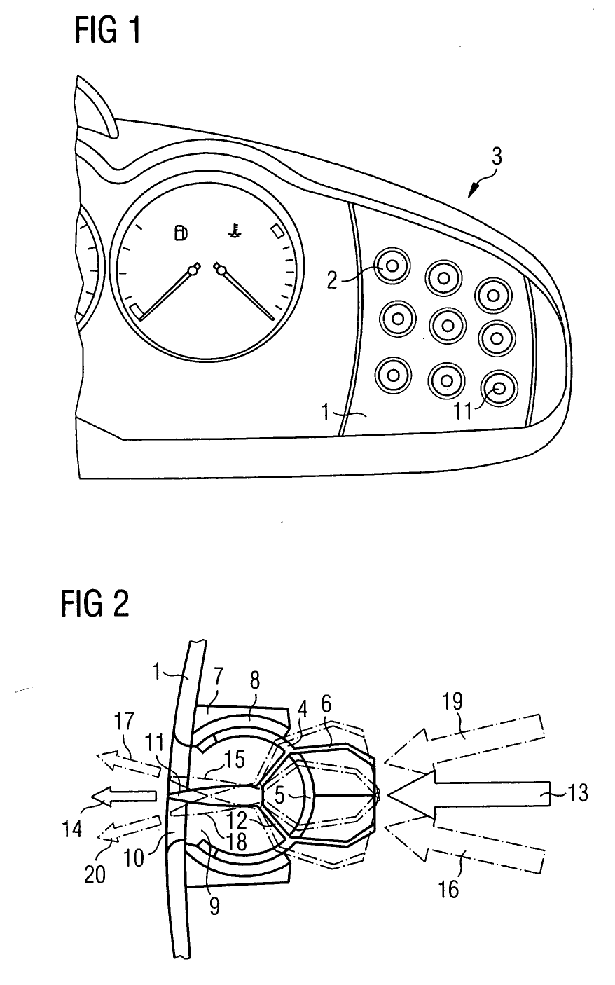

FIG. 1 illustrates the right-hand side of a vehicle cockpit as seen by the passengers, in the side faceplate 1 of which cockpit are mounted nine ball nozzles 2. The nine ball nozzles 2 are arranged in a three-by-three matrix of ball nozzles 2 and as a whole form an air outflow device 3. The air from a heating and climate control unit (not illustrated) of the vehicle flows out through the air outflow device.

FIG. 2 is a sectional diagram through one of the ball nozzles 2 mounted in the vehicle cockpit. A spherical air guide element 4 has a first opening 5 which is enclosed by a cylindrical air connecting element 6 which is integrally formed on the air guide element 4. An air feed line (not illustrated) is connected to the air connecting element 6 and is in turn connected to the heating and climate control unit. The air guide element 4 is mounted in a bracket 7 which has a spherical inner shape 8 which is matched to the spherical shape of the air guide element 4. A second opening 9 in the air guide element faces in the direction of an opening 10, which is formed in the faceplate 1 of the cockpit, and thus in the direction of the vehicle interior. A nib 11 is arranged centrally in the interior of the air guide element 4 and is connected to the air guide element 4 by means of webs 12. The nib 11 projects into the faceplate 1 and ends flush with the latter. An operator can grip the air guide element 4 and rotate it into a desired position by means of said nib 11. In the air outflow device 3 illustrated in FIG. 1, all of the ball nozzles 2 are aligned such that their nibs 11 are situated centrally in the openings of the faceplate 1. In FIG. 2, in addition to the central alignment, two other positions of the nib 11 and thus of the air guide element 4 which are displaced to the side of the centre are indicated. The corresponding profile of the air flow is indicated by the associated arrows. In the central position, the air enters the air guide element 4 according to the arrow 13 and flows straight out of the faceplate opening 10 according to the arrow 14. The profile of the air flow with a first lateral adjustment of the nib 11 in the direction 15 is indicated by the arrows 16 and 17, and in a position in the direction 18 by the arrows 19 and 20.

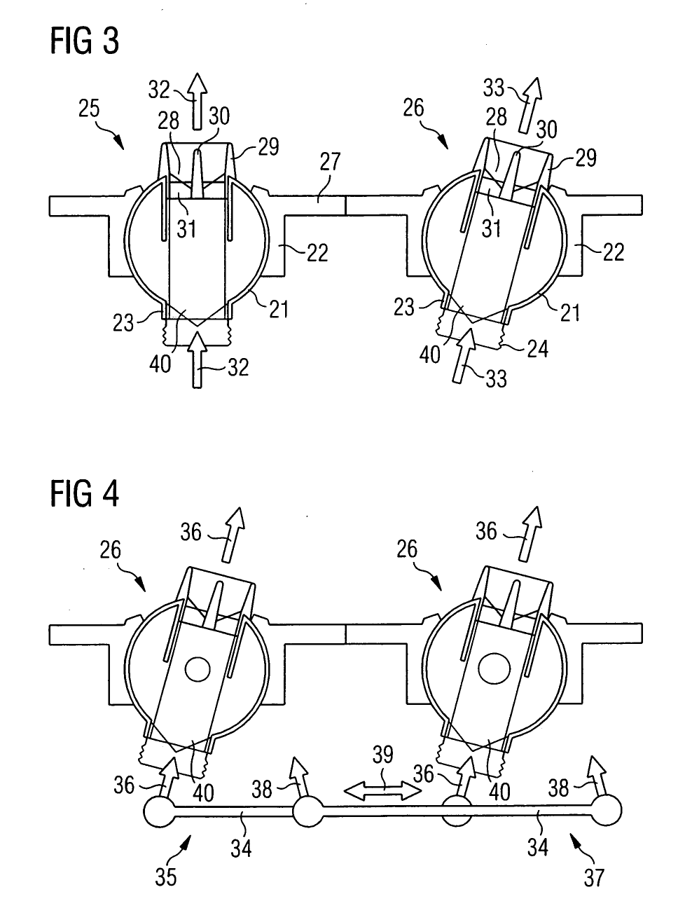

FIG. 3 illustrates two individually adjustable ball nozzles 25 and 26 which are arranged next to one another in a faceplate 27. Again, one spherical air guide element 21 is situated in each case in a correspondingly formed bracket 22. One cylindrical air connecting element 23 is integrally formed on the first opening 40 of each air guide element 21, into which air connecting element 23 is inserted an air feed line 24. A cylindrical air outflow element 29 is integrally formed on the second opening 28, which points in the direction of the faceplate 27, of the air guide elements 21, in the centre of which air outflow element 29 is situated in each case a nib 30 which is connected to the air guide element 21 by means of webs 31. The ball nozzle 25 is aligned centrally, that is to say the air flow 32 runs through the faceplate 27, perpendicularly to it, and out of the air outflow element 29, while the ball nozzle 26 is inclined to the right, and the air flow 33 correspondingly runs at an inclined angle to the faceplate 27.

FIG. 4 shows two ball nozzles 26 which are connected to one another by means of a connecting rod 34 which can be moved in the direction 39. The connecting rod 34 is only indicated schematically in FIG. 4 in two possible positions, the position 35 corresponding to the illustrated position of the ball nozzles 26. In this position, the ball nozzles 26 are inclined to the right relative to the faceplate 27, and the air flow runs in the direction 36. In the position 37, the air would then flow in the direction 38.

What is claimed is:

1. An air outflow device comprising an air guide element , which is provided with an opening on each of two sides, is rotatably mounted in a bracket which is open on two sides and is matched to a shape of the air guide element, the first of the two openings of the air guide element being connected to an air feed line, and the second of the two openings being directed towards a space which is to be ventilated, wherein the air outflow device is formed by at least two air guide elements which are each mounted in a bracket and are arranged next to one another in a faceplate which adjoins the space which is to be ventilated.

2. The air outflow device as claimed in claim 1, wherein more than two air guide elements are distributed across an area of the faceplate in a matrix-like arrangement of equal numbers of air guide elements arranged one above the other and next to one another.

3. The air outflow device as claimed in claim 1, wherein the at least two air guide elements are of equal size.

4. The air outflow device as claimed in claim 1, wherein at least two of the air guide elements can be moved independently of one another in their respective brackets.

5. The air outflow device as claimed in claim 1, wherein least two of the air guide elements are mechanically connected to one another on the side of their first openings by a connecting rod, and can be moved in a same way.

6. The air outflow device as claimed in claim 1, wherein for at least two of the air guide elements, a strength of the air flow supplied may be set.

7. The air outflow device as claimed in claim 1, wherein the air guide element and an inner shape of the bracket are spherical.

8. The air outflow device as claimed in claim 7, wherein a handling element projects out from the interior of each air guide element.

9. The air outflow device as claimed in claim 8, wherein the handling element is a nib which is arranged centrally in the second opening of the air guide element.

10. The air outflow device as claimed in claim 7, wherein a cylindrical air connecting element is integrally formed on the first opening of the air guide elements.

11. The air outflow device as claimed in claim 7, wherein a cylindrical air outflow element is integrally formed on the second opening of the air guide elements.
